(19) United States
(12) Patent Application Publication
(10) Pub. No.: US 2009/0147159 A1
(43) Pub. Date: Jun. 11, 2009

(54) PROJECTOR

(75) Inventor: S-Wei Chen, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: YOUNG OPTICS INC., Hsinchu (TW)

(21) Appl. No.: 11/951,377

(22) Filed: Dec. 6, 2007

(51) Int. Cl. G02F 1/1333

(52) U.S. Cl. 349/8

(57) ABSTRACT

A projector includes a plurality of light sources, a liquid crystal display panel, a field lens and a flat mirror. The light sources provide color light beams. The liquid crystal display panel is capable of full color display. The field lens is disposed between the light sources and the liquid crystal display panel. The flat mirror is disposed between the light sources and the field lens. The light beams are reflected by the flat mirror to the field lens, and then pass through the field lens and change in different directions, entering the liquid crystal display panel with different incident angles. The projector further includes a curved mirror. The curved mirror replaces the field lens and the flat mirror. The light beams are reflected by the curved mirror and change in different direction, entering the liquid crystal display panel with different incident angles.

### BACKGROUND OF THE INVENTION

1. Field of the Invention

The invention provides a projector, and in particular, provides a projector with a simplified structure and miniaturized size.

2. Description of the Related Art

As shown in FIG. 1, the conventional projector 10, an LCD projector in particular, usually comprises multiple dichroic mirrors D to selectively pass light of a small range of colors, while reflecting other colors, such that white light provided by the light source 11 is being deliberately separated into various color light beams. These color light beams then enter into the LCD panel 12 with different incident angles.

However, light efficiency is decreased about two percent after passing each dichroic mirror D. In the conventional projector 10, two dichroic mirrors D are utilized to separate the blue light beam and the green light beam from the white light, and the red light beam is left out to be reflected by a reflecting mirror R, such that maximum light efficiency cannot be achieved by the conventional projector 10. Material and manufacturing costs are also increased due to additional components required.

### SUMMARY

The invention provides a projector. In one embodiment of the present invention, the projector comprises a plurality of light sources, a liquid crystal display panel and a field lens. The light sources provide color light beams emitted. The liquid crystal display panel is capable of full color display. The field lens is disposed between the light sources and the liquid crystal display panel. The light beams pass through the field lens and change in different directions, entering the liquid crystal display panel with different incident angles.

In one embodiment of the present invention, the projector comprises a plurality of light sources, a liquid crystal display panel and a curved mirror. The light sources provide color light beams. The liquid crystal display panel is capable of full color display. The curved mirror is disposed between the light sources and the liquid crystal display panel. The light beams are reflected by the curved mirror and change in different directions, entering the liquid crystal display panel with different incident angles.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The invention can be more fully understood by reading the subsequent detailed description and examples with references made to the accompanying drawings, wherein:

FIG. 1 is a schematic view of a conventional projector;

FIG. 2A is schematic view showing an embodiment of a projector of the invention;

FIG. 2B is a schematic view showing a variant embodiment of the projector of the invention; and

FIG. 2C is a schematic view showing another variant embodiment of the projector of the invention.

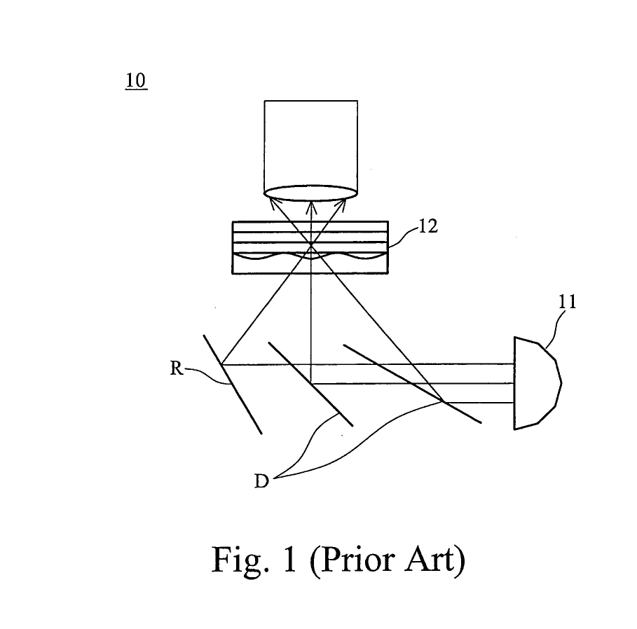

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

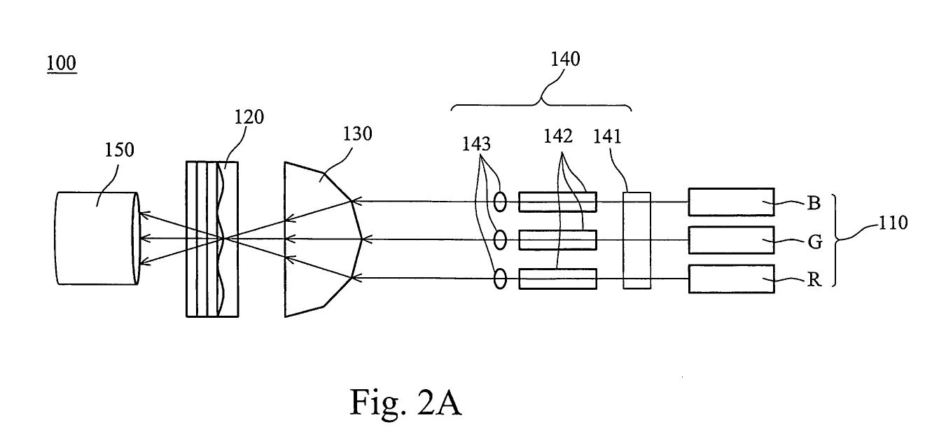

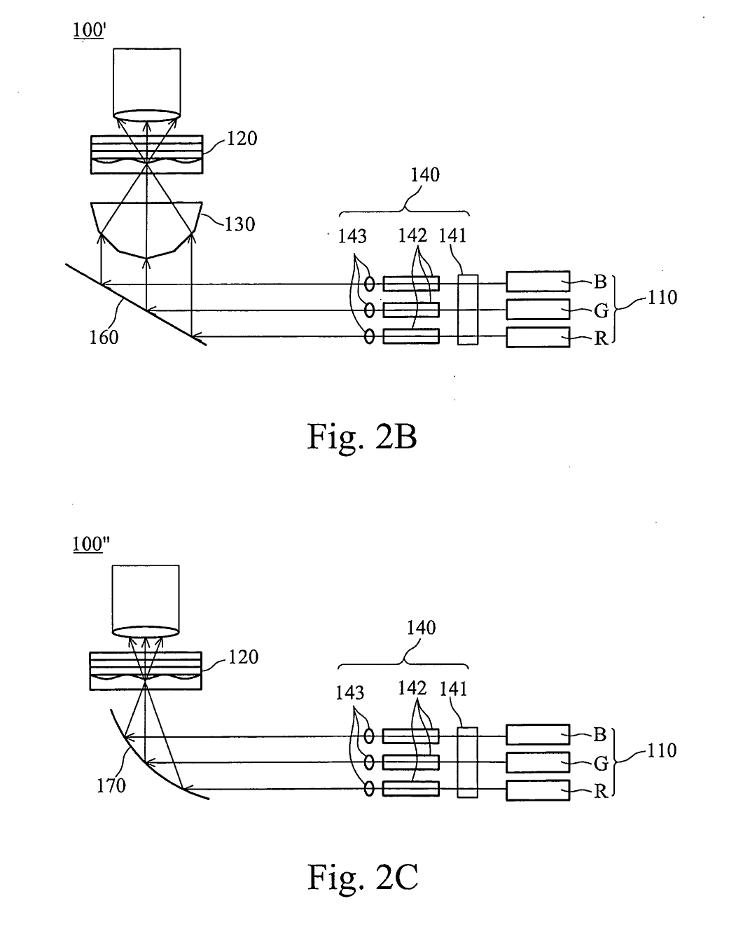

One embodiment of the present invention provides a projector 100, and the interior of the projector 100 is shown in FIG. 2A. The projector 100 comprises a plurality of light sources 110, a liquid crystal display panel (LCD panel) 120, a field lens 130, an optical assembly 140 and a projection lens 150. The light sources 110 provide light beams to pass through the optical assembly 140 and the field lens 130, entering the LCD panel 120 to be switched into images. Finally, the images are projected through the projection lens 150.

The light sources 110 comprises a blue laser B providing blue light beam, a green laser G providing green light beam, and a red laser R providing red light beam. The blue laser B, the green laser G and the red laser R are disposed adjacent to each other and emit light toward the same direction, such that the blue light beam, the green light beam and the red light beam are parallel to each other. Please note that light paths are shown by arrows in FIG. 2A.

It should be noted that in this embodiment, the light source 110 are disposed to provide color light beams in parallel, but it is not limited thereto. The light source 110 can also be disposed to provide color light beams not parallel to each other according to demand.

The LCD panel 120 requires different colors of light beams to enter with different incident angles. Thus, the field lens 130 is disposed between the light sources 110 and the LCD panel 120, and adjacent to the LCD panel 120. Before entering the LCD panel 120, the parallel light beams pass through the field lens to change in different directions, allowing the light beams in different colors to enter the LCD panel 120 with different incident angles.

The optical assembly 140 is disposed between the light sources 110 and the field lens 130, comprising a despeckler 141, three integrators 142 and three condensing lens 143. The despeckler 141 is utilized for best noise reduction. Each integrator 142, a rod or a fly-eye lens array, is disposed corresponding to each light source 110, respectively, and is utilized to provide uniform illumination by homogenizing the light from the light sources 110. Each condensing lens 143 is disposed corresponding to each light source 110, and is utilized to condense light beams provided by the light sources 110. However, it should be noted that the optical assembly 140 is provided to increase the quality of light, but it is not limited thereto. The optical assembly 140 can comprises other optical components to improve the quality of light. Additionally, a single despeckler 141 is comprised to save cost in this embodiment, but it is not limited thereto. Three despecklers 141 can be comprised corresponding to different light sources 110 according to requirements.

The light beams in different colors, provided by blue laser B, the green laser G and the red laser R, in parallel pass through the optical assembly 140 and the field lens 130, and are refracted by the field lens 130 in different directions, allowing the light beams in different colors to enter the LCD panel 120 with different incident angles. Light beams, entering the LCD panel 120, are switched into images, and projected through the projection lens 150 disposed next to the LCD panel 120.

A variant embodiment of the projector 100′ is shown in FIG. 2B. In order to assemble a more compact projector, the projector 100′ further comprises a flat mirror 160 disposed between the field lens 130 and the optical assembly 140. The light beams, provided by the light sources 110, in parallel pass the optical assembly 140 and are reflected by the flat mirror 160. The light beams are reflected 90 degrees, but still parallel to each other, toward the field lens 130 and pass the field lens 130, allowing the light beams in different colors to enter the LCD panel 120 with different incident angles. Light beams, entering the LCD panel 120, are then modulated into image beams, and the image beams are projected on a screen through the projection lens 150. Because the light path is changed in direction by the flat mirror, the disposition of the components within the projector 100′ can fit tightly, reducing overall size of the projector 100′.

Another variant embodiment of the projector 100″ is shown in FIG. 2C. The projector 100″ comprises a curved mirror 170, disposed between the LCD panel 120 and the optical assembly 140, to replace the field lens 130 and the flat mirror 160 of the projector 100′. The light beams, provided by the light sources 110, in parallel pass the optical assembly 140 and the curved mirror 170 in sequence. The light beams are respectively reflected in different directions according to curvature of the curved mirror 170, allowing the light beams in different colors to enter the LCD panel 120 with different incident angles. Light beams, entering the LCD panel 120, are then modulated into image beams, and the image beams are projected through the projection lens 150. The field lens 120 and the flat mirror 160 are replaced by the curved mirror 170 to achieve the objective of miniaturization.

The projector 100, 100′, 100″ of the embodiments of the invention comprises a blue laser B, a green laser G and a red laser R. The light sources are disposed adjacent to each other, to provide light beams parallel to each other. The dichroic mirrors, used to separate light beams, can be eliminated, such that light efficiency is fully distributed and the material cost is successfully reduced. In addition, the field lens 130 helps the light beams to enter the LCD panel 120, accomplishing a complete light path. The flat mirror 160 changes the direction of light beams to keep the projector more compact. The replacement of the curved mirror 170 further fulfills the purpose of reducing material cost.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector, comprising:
a plurality of light sources providing color light beams;
a liquid crystal display panel capable of full color display; and
a field lens disposed between the light sources and the liquid crystal display panel;
wherein the light beams pass through the field lens to change the directions thereof into be different each other and then enter the liquid crystal display panel with different incident angles.

2. The projector as claimed in claim 1, further comprising an optical assembly disposed between the light sources and the field lens, wherein the light beams pass through the optical assembly before passing through the field lens.

3. The projector as claimed in claim 2, wherein the optical assembly comprises an integrator, a despeckler and a condensing lens.

4. The projector as claimed in claim 3, wherein the integrator is a rod or a fly-eye lens array.

5. The projector as claimed in claim 2, further comprising a flat mirror disposed between the optical assembly and the field lens, wherein the light beams, provided in parallel, are reflected by the flat mirror to the field lens.

6. The projector as claimed in claim 1, wherein the light sources comprises a blue laser, a green laser and a red laser.

7. The projector as claimed in claim 1, further comprising a projection lens disposed next to the liquid crystal display panel, wherein the light beams are modulated into image beams by the liquid crystal display panel, and the image beams are projected on a screen through the projection lens.

8. The projector as claimed in claim 1, further comprising a flat mirror disposed between the light sources and the field lens, wherein the light beams provided in parallel are reflected by the flat mirror to the field lens.

9. The projector as claimed in claim 1, wherein the field lens is disposed adjacent to the liquid crystal display panel.

10. A projector, comprising:
a plurality of light sources providing color light beams;
a liquid crystal display panel capable of full color display; and
a curved mirror disposed between the light sources and the liquid crystal display panel;
wherein the light beams are reflected by the curved mirror to change the directions thereof into be different each other and then enter the liquid crystal display panel with different incident angles.

11. The projector as claimed in claim 10, further comprising an optical assembly disposed between the light sources and the curved mirror, wherein the light beams pass through the optical assembly and the curved mirror in sequence.

12. The projector as claimed in claim 10, wherein the optical assembly comprises an integrator, a despeckler and a condensing lens.

13. The projector as claimed in claim 12, wherein the integrator is a rod or a fly-eye lens array.

14. The projector as claimed in claim 10, wherein the light sources comprises a blue laser, a green laser and a red laser.

15. The projector as claimed in claim 10, further comprising a projection lens disposed next to the liquid crystal display panel, wherein the light beams are modulated into image beams by the liquid crystal display panel, and the image beams are projected on a screen through the projection lens.

16. The projector as claimed in claim 10, wherein the light beams provided by the light sources are parallel to each other.
